(19) United States
(12) Patent Application Publication
(10) Pub. No.: US 2003/0158928 A1
(43) Pub. Date: Aug. 21, 2003

(54) Systems and methods for supporting the delivery of streamed content

(76) Inventors: Christopher R. Knox, San Diego, CA (US); James S. Sherry, San Diego, CA (US); Troy S. Snyder, San Diego, CA (US); Randy Levine, San Diego, CA (US)

Correspondence Address: ROPES & GRAY LLP, ONE INTERNATIONAL PLACE, BOSTON, MA, 02110-2624, US

(21) Appl. No.: 10/293,946

(22) Filed: Nov. 13, 2002

Related U.S. Application Data
(63) Continuation-in-part of application No. 09/853,444, filed on May 11, 2001, now abandoned.
(60) Provisional application No. 60/237,796, filed on Oct. 4, 2000.
(60) Provisional application No. 60/251,826, filed on Dec. 7, 2000.

(30) Foreign Application Priority Data
Oct. 4, 2001 PCT/US01/31127

(51) Int. Cl. G06F 15/173

(52) U.S. Cl. 709/223

(57) ABSTRACT

Server systems have distributed file systems that provides services for loading, staging, distributing and delivering streamed media content. The file system may be remotely accessible through a web browser, or other client application. The file system described herein can allow a customer of the hosting server to access and control the web site files from a remote location, and manipulate and manage the files stored on the host site, to configure the site as desired. To this end, the distributed file system provides a process for allowing a user to upload streaming media content from a client site to the host, or to another location accessible by the file system. A staging process allows the user to set or adjust meta-data characteristics of the uploaded media asset, and a distribution process is capable of replicating the media asset and distributing the replicated versions of that asset across the data network.

### REFERENCE TO RELATED APPLICATIONS

This case is a Continuation-in-Part claims priority to U.S. application Ser. No. 09/853,444 filed May 11, 2001 and Provisional Application Serial No. 60/237,796 filed Oct. 4, 2000, entitled SYSTEMS AND METHODS FOR SUPPORTING THE DELIVERY OF STREAMED CONTENT, and U.S. Provisional Application Serial No. 60/251,826 filed Dec. 7, 2000, entitled SYSTEMS AND METHODS FOR SUPPORTING THE DELIVERY OF STREAMED CONTENT.

### BACKGROUND OF THE INVENTION

Presently, the demand for web-hosting services that support the unique requirements of streamed content is largely unmet. Moreover, this demand is expected to grow rapidly over the next few years as more and more streaming applications are developed and available for deployment. In fact, it is predicted that in a short time streamed content will become the majority of content delivered over the Internet.

However, managing a website that provides streaming media content can be quite difficult, particularly as the tools that exist today for managing a website are largely directed to managing conventional websites that do not provide streaming content, or have limited streaming content at the site. In a typical situation, there is a hosting service that maintains the server, data storage, and network accessibility. The hosting service therefore provides a robust and reliable platform for supporting a user's website. The website can be for an individual, a company, or any other type of entity. In pretty much all cases, at least one user is associated with each website, and that user is given an account by the web host that provides access to the user for allowing the user to store and manage data files, executable programs, access controls, and other information on the web site. To manage the web site the user either goes directly to the hosting service facility or employs software tools for remotely accessing the server and setting up the site to operate that user wishes. When the user is at the site, the host site administrator typically gives the user access to a network terminal and a shell account that allows the user to use the local operating system to load files and otherwise organize the web site.

However, if the user wishes to access the site remotely, the burden is typically on the user to find the appropriate software tools to access the host server and manage the web site. The software tools available to a user typically include a file transfer protocol (FTP) program that runs on the user's client machine and accesses an FTP server provided by the web host. The FTP server allows the user to access the host operating system and typically use UNIX shell commands to move files, copy files, name and rename files, and other basic shell functions. These programs are provided by third-party software vendors and purchased by the user for the purpose of accessing and maintaining their website. Although these systems can work quite well for allowing a user to manage a simple web site comprised of non-streamed content, these systems are somewhat cumbersome and require that the user learn how to control the new software tool before being able to manage their website.

Yet these tools are generally sufficient for managing simple web sites. However, a user wishing to add streaming media assets to their website is faced with a more challenging scenario. This challenge arises in part from the fact that files of streaming media assets are different from conventional static data files. In particular, streaming media assets, such as data files representative of video, audio, and other multimedia content, are considerably larger than conventional static data files. For example, a typical data file having multimedia content in it may be 100-1,000 Megabites in size. In contrast, a conventional web page will typically range from 10-200 Kilobytes. Additionally, streaming media data files are more complex than conventional static web pages. For example, streaming media files are suited for certain bit rates, and the same content may be produced in several different formats, each format being tailored for a particular bit rate of distribution and codes. Similarly, streaming media assets can have additional meta-data, such as a start time and a stop time for the media play. Streaming media assets are also more likely to require replication and network distribution than conventional media assets. Finally, streaming media assets are more sensitive to the quality of service employed for delivering those streaming media assets.

The conventional tools in place for allowing a user to upload a data file onto a website and manipulate meta-data characteristics for that data file are poorly suited to applications that involve streaming media assets. For example, if a user wishes to upload a data file with an edited start and stop time, conventional FTP programs require the user re-upload completely that file. Given the size of these streaming media assets, an upload operation may take two to thirty minutes. This can result in a substantial time delay for the user who is trying to set up the website as quickly as possible. It also results in down time during which the streaming media asset is not available for download to web site visitors.

Additionally, if a user changes the meta-data associated with a file, that meta-data needs to be changed with each replicated copy of that data file. Accordingly, as the user changes the data file, that changed data file may need to be replicated and redistributed across all different distribution sites of the network. Finally, conventional tools today are poorly suited for measuring the quality of service provided when delivering a streaming media asset, or even a static media asset. As such, users are provided with limited ability to determine the quality of service given by a web host provider.

Accordingly, there is a need in the art for new tools for allowing a user to more easily manage a website having streaming media content.

### SUMMARY OF THE INVENTION

To address these and other issues, the systems and methods described herein provide, inter alia, a system for allowing a user to manage a web site that offers streaming media assets for delivery across a data network. More particularly, the systems and methods described herein provide a remotely accessible distributed file system adapted for managing files that are to be streamed over a data network. The management of files may include allowing the user to set up accounts and sub accounts on a host system, manage user names, passwords, and privileges, FTP encoded files to the host, create integration points that users activate to run streams, reclaim files that have been recycled, select runtime attributes for each stream, including the networks that will carry the stream, as well as information about the file, including title, author, watermark, or copyright.

In one embodiment, these systems of the invention include server systems having the distributed file system described herein executing thereon. The distributed file system provides services that may be employed by a user for loading, staging, distributing and delivering a streaming media asset. The file system may be remotely accessible through a web browser, or other client application. Accordingly, a hosting site having the file system described herein can allow a user to access the file system from a remote location, and manipulate and manage the files stored on the host site, to configure the site as desired. Once accessed, the distributed file system provides a process for allowing a user to upload streaming media content from a client site to the host, or to another location accessible by the file system. The system further includes a staging process that allows the user to set or adjust characteristics of the uploaded media asset. For example, the user may adjust the title, run start time, run stop time and other characteristics of the media asset. Files uploaded to the server may be processed by a file system distribution process capable of replicating the media asset and distributing the replicated versions of that asset across the data network.

Optionally, the distribution of the replicated media assets may include the distribution of that asset to a content delivery network, such as for example the Akamai distribution network. To this end, the distributed file systems described herein include processes for allowing a user to modify a media asset distributed across a content overlay network.

In one particular embodiment, such distributed file systems employ geographically redundant mirrored data and a backend seamless replication process that enables large amounts of streaming media content to be published, distributed and managed on to a network, such as the Internet. In operation, the distributed file system replicates and distributes files across the mirrored data sites on the Internet. The distributed file system tracks the location of the distributed content files and directs requests for content to the optimal streaming source. Thus, the distributed file system leverages existing overlay networks and moves data automatically across these overlay networks to more efficiently provide hosting services to the streaming media customer. Additionally, the distributed file system includes a process for collecting long-term historical data of file distribution, thereby providing users a “one-glance” overview of their content and how it is deployed across the file system and the network.

More particularly, the systems and methods described herein include a computer network system for supporting a user in managing streaming media assets. Such computer network systems may comprise a server having an upload process for receiving a media asset having content for being streamed across a data network, a check-in process for allowing a user to assign meta-data to the media asset, a storage process for replicating and for storing the media asset across storage devices distributed across the computer network system and an editing process for allowing a user to modify the meta-data and for propagating modifications to the meta-data to the replicated and stored media assets.

In certain ones of these embodiments, the system may include a check-in process that allows a user to assign meta-data representative of data selected from a group consisting of file title, file author, run start point, run stop point and bit rate. The server may comprise a webserver for exchanging data with a web client and for allowing a web client to access services provided thereby. The system may include a web client that is a web browser or player, such as the type of web browser or player capable of displaying streamed media content.

In a further embodiment, the systems may comprise a link generator process for generating an embeddable link for accessing a media asset. The link generator process may comprise a process for generating an embeddable link for accessing a media asset stored on the server. Alternatively, the link may be used for accessing a media asset stored on a local server system. The system may also include a storage process that includes an overlay process for storing media assets across a content delivery network.

In further embodiments, the system may include a monitoring system having a plurality of agents located on the computer network incapable of monitoring characteristics of a delivery process for transmitting a streaming media asset from the server. The system may include a plurality of agents where the agents are capable of monitoring characteristics representative of the quality of service of the delivery process. The characteristics representative of a quality of service may include characteristics selected from the group consisting of average bit rate, packet loss, and latency.

In a further embodiment, the server may also comprise a process for receiving information from at least one of the plurality of agents for generating a report representative of the quality of service provided during the delivery of the streaming media asset. Additionally and optionally, a load balancing system may be provided as well as a distribution system for determining a storage location on the network for the streaming media asset as a function of the network proximity to one or more nodes likely to request access to the respective streaming media asset.

In still further embodiments, the distributed file system described herein may include a privilege control process for providing different users with different privileges and different rights to services.

Accordingly, it will be seen from the above, and described in more detail below, with reference to certain figures illustrating exemplary embodiments of the systems and methods of the invention, that the described distributed file systems may be employed by a hosting service to provide customers with tools that make managing their site more facile. Thus, hosting service can provide customers with a file system that can be accessed remotely by a customer and includes a feature that replaces non-scaleable processes like FTP, and TELNET with processes that can move multiple large files in a single operation. The distributed file system also eliminates or reduces manual meta file data creation, which hinder the rapid deployment of content, and decouples the editing of meta file data from the editing of the file. Thus a customer can change the name of a file, the start or stop times, the associated codes or other meta data, while that file is on the remote server, without having to edit the file on the client side and upload the edited file to the server.

### BRIEF DESCRIPTION OF THE ILLUSTRATED EMBODIMENTS

The foregoing and other objects and advantages of the invention will be appreciated more fully from the following further description thereof, with reference to the accompanying drawings wherein;

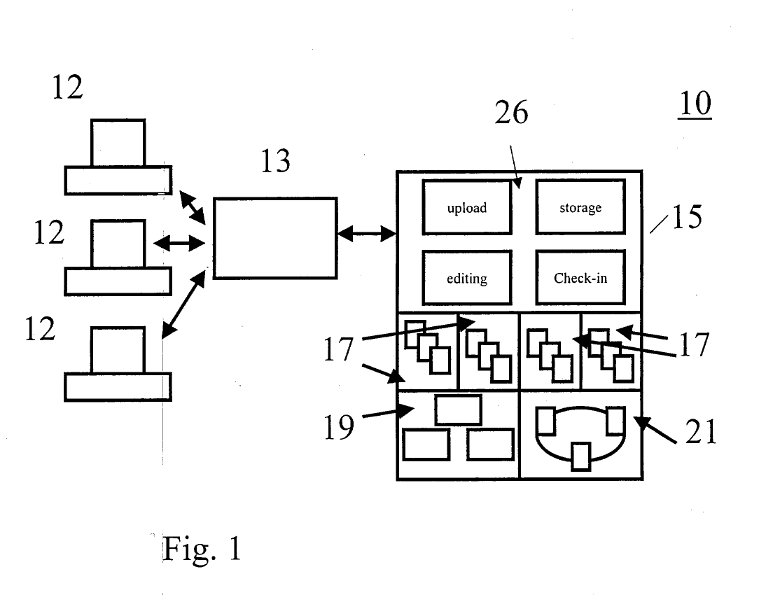

FIG. 1 depicts an overview of one system according to the invention;

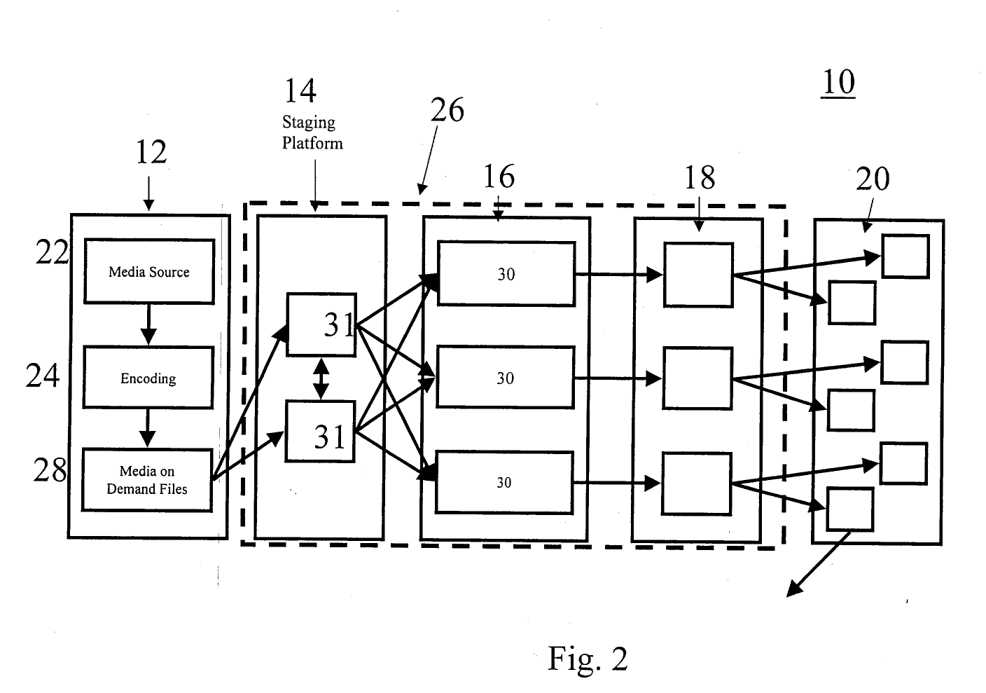

FIG. 2 depicts in more detail the system of FIG. 1;

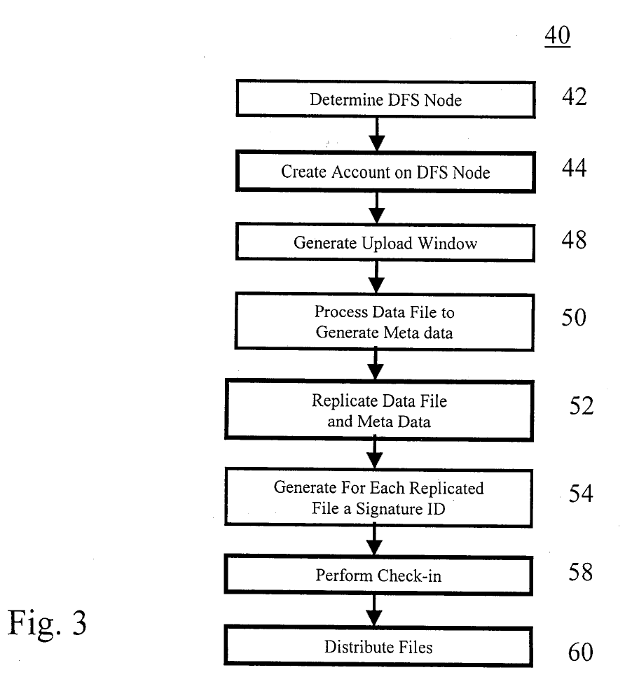

FIG. 3 depicts one process according to the invention;

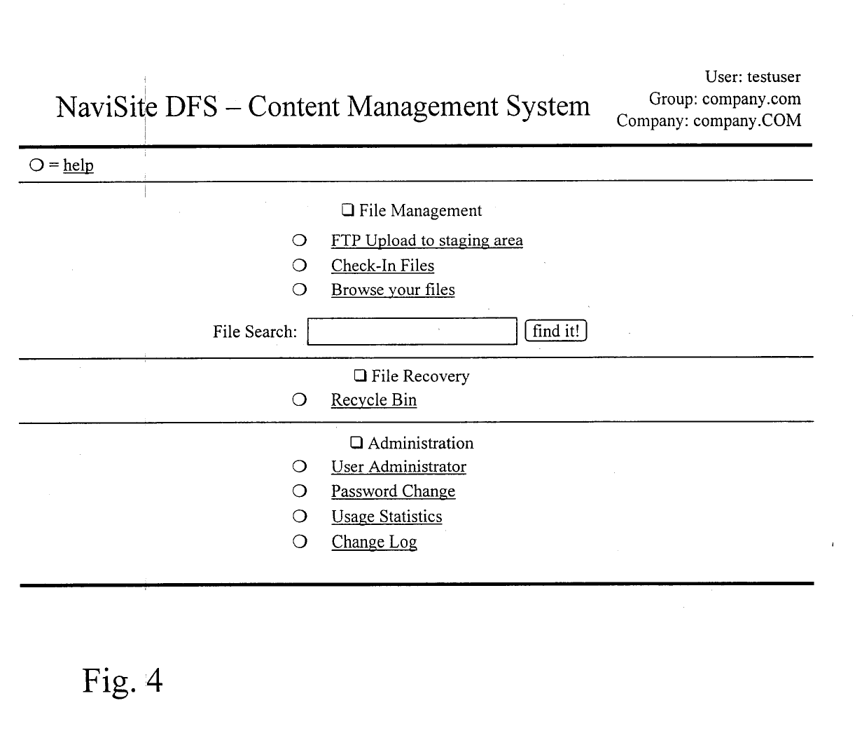

FIGS. 4-9 series of user interface screens provided by the system of FIG. 1 for allowing a user to manage content on a website; and

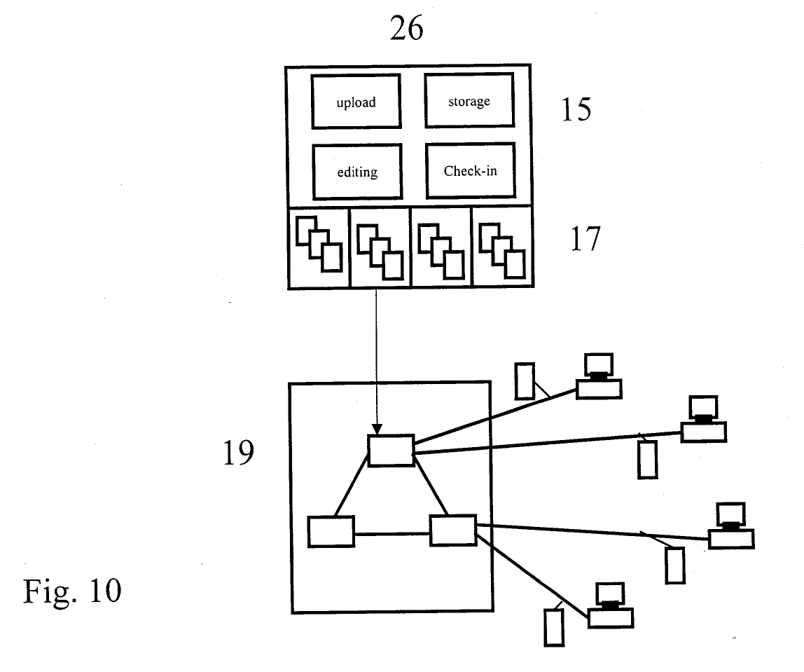

FIG. 10 depicts an alternative embodiment of the invention having a plurality of monitoring agents for monitoring quality of service provided to a customer.

### DETAILED DESCRIPTION OF CERTAIN ILLUSTRATED EMBODIMENTS

To provide an overall understanding of the invention, certain illustrative embodiments will now be described. To this end, the below description provides an example of how a web hosting service would use the distributed file system of the invention to allow a user to manage web sites having streamed media content. However, other applications of the invention may be developed by those of ordinary skill in the art and it will be understood by one of ordinary skill that the systems and methods described herein can be adapted and modified for other suitable applications and that such other additions and modifications will not depart from the scope hereof.

The systems and methods described herein include a file management and delivery platform well suited for supporting and hosting streaming centric applications. As will be described in more detail hereinafter, the systems may include a distributed file system for providing file system control over a plurality of distributed, replicated data files, that are typically, multi-media data files. The distributed file system sits as a layer between an application program, such as an FTP application, and a plurality of data storage devices, that may be in one embodiment a plurality of servers that store the data files for subsequent delivery to a client computer. Optionally, the systems described herein may include a quality of service process that employs a plurality of monitors located at nodes across the network. A typical monitor may comprise a Linux Workstation running an agent that simulates the actions of a Windows Media player, a Quicktime player and other relevant applications. The agents will gather stream-specific data from many different locations throughout the network and transfer the information back to a central depository where it is parsed, processed, and made available for client access and review. Thus, quality of service may be monitored and monetorized by the systems described herein.

FIG. 1 depicts a computer network system 10 that includes the distributed file system of the invention for allowing a plurality of clients to manage the streaming media content and streaming media operations of a web site. The computer system 10 of the invention can comprise conventional network components. For example, the client devices 12 can be conventional commercially available client devices, including desktop workstations, handheld devices, telephones, and any suitable proprietary device that can run a client application suitable for interacting with a network server. The depicted server 13 is an HTTP server, although other servers for different protocols may be employed depending upon the application. The server 13 can similarly be any of the commercially available server systems, including the Apache server or other server that operates on conventional processing platforms such as an IBM PC-compatible computers running the Windows operating systems, or a SUN server running a Unix operating system.

The clients and server can exchange information over any network system, including the Internet, an enterprise network, a LAN, or any other type of network platform. FIG. 1 further depicts an application server 15 that communicates with the server 13. The application server 15 comprise a conventional commercially available server platform capable of hosting and supporting a plurality of different applications. For the depicted system 10, the application server 15 supports the distributed file system 26 of the invention. The application server 15 additionally supports a plurality of websites 17. The websites of FIG. 1 are depicted by showing four separate functional blocks. Each functional block 17 has a plurality of files stored therein. Accordingly, for the purpose of describing the present invention a website is to be understood as a collection of content, such as webpages, scripts and streaming media content that is associated or referred by a particular network address. In the depicted embodiment the websites 17 are shown as being supported by the same platform that supports the distributed file system 26. However, it will apparent to those of ordinary skill in the art that the websites 17 may be supported by separate, independent platforms. The actual organization and distribution of the websites 17 will vary depending upon the application.

FIG. 1 further depicts pictorially two other elements, a set of geographically distributed servers 19, and a third party content network 21. The geographically distributed servers 19 and the third party content network 21 are shown as functional blocks connected to the server 15 for the purpose of showing that the server 15 can communicate and exchange data with these two elements 19 and 21. The geographically distributed servers 19 represent a set of servers that are distributed across a geographic location, such as North America, and will further be understood as servers that are distributed across a network, or a portion of a network. The schematic representation by the functional block 19 of the distributed servers is meant to represent that the hosting service associated with the server 15 may include a set of geographically distributed servers. For example, the NaviSite Company maintains webservers in Massachusetts and in California. Content from a website hosted by NaviSite can be served from either of these geographic locations. The selection of which servers are activated to surface a request for content depends on a number of factors including network load, expected latency for data delivery and other factors commonly consider when determining which server should respond to a request for data from a web site visitor. The design and development of such geographically distributed server platforms is well known in the art. Similarly, the functional block 21 schematically represents a third party content network that can receive content from web site and support delivery of that content to a web site visitor. The design and architecture of such third party content networks, such as the previously mentioned Akamai overlay network, is well known in the art, and described in the literature including U.S. Pat. No. 6,108,703. As will be described in greater detail hereinafter, the server system 15 can allow for the replication of website content from the websites 17 with the distribution of the replicated content across the different distributed servers of the element 19. Similarly, the third party content network 21 represents a third party network such as the Akamai network. As with element 19, the third party content of network 21 is shown as being connected to the server 15 to illustrate that the server 15 can exchange data with the third party content network 21 to effect the distribution of website content.

More particularly, FIG. 2 depicts the network system 10 in more detail wherein the plurality of client's 12 interact with the distributed file system 26 of the invention. The depicted clients 12 are shown in FIG. 1 as conventional desktop computer systems of the type capable of running a client application, such as a browser program, for allowing the client 12 to communicate with the server system 13. The clients 12 allow individual web site managers to control their web sites remotely through a web access interface provided through the web server 13. To this end, the web server 13 maybe a conventional web server, such as the Apache web server running on a server hardware platform capable of servicing requests received from a plurality of clients. The web server may, as depicted in FIG. 1, communicate with the distributed file system 26 by treating the distributed file system 26 as an application running on an application server. However, it will be apparent to those of ordinary skill in the art that the architecture where the web server 13 is separate from the distributed file system 26 is merely one embodiment of the invention and that other architectures may be employed without departing from the scope thereof, with the selected architecture often depending on the application at hand.

The distributed file system 26 depicted in FIGS. 1 and 2 provides a plurality of services that can be accessed by the client's 12 through the web server 13. Each of the services facilitates the manipulation of content, and in particular, streaming media content, provided by a client for distribution over a data network, such as the Internet. FIG. 1 shows the distributed file system 26 as comprising of plurality of processes including an upload process 30, storage process 32, editing process 34 and check-in process 38. Those of ordinary skill in the art will know that a file system, such as the file system 26, is responsible for providing services that create and organize data files stored on a computer system. A file system typically comprises a plurality of different processes all of which cooperate together for the purpose of providing a user with control over file creation and file management. The distributed file system 26 depicted in FIG. 1 includes four processes for the purpose of allowing a user to use a client 12 to load streaming media content onto a web site 17 associated with that user and manage the uploaded data files that are to be distributed as streamed content over a data network.

To this end, FIG. 1 depicts a number of different web sites 17. A web site, for the purpose of this description, will be understood as a directory or several directories of content, including optionally executable content, that is associated with a network address and that is to be delivered over the Internet either as data content or a service. In FIG. 1, the four different web sites are shown as having a set of files in this case, each web site having three files. However, this is just an arbitrary number of files shown for the purpose of illustrating the structure and operation of the distributed file system 26. For the purpose of this description, each of the three depicted files for each web site is representative of a streaming media asset. A streaming media asset typically would be an Mpeg file, AVI file, or some other type of audio, visual or audiovisual file that has been translated into a streaming format such as Real Media, Windows Media or QuickTime. The software transcoders needed for performing this type of translation are available and any suitable software for performing this translation may be employed to generate the files depicted in the web site 17 of FIG. 1. The upload, storage, editing and check-in processes of the distributed file system 26 enable a client 12 to upload a data file from one of the client's 12 and into the respective web site associated with that client 12. Additionally, the distributed file system includes processes that allow the client to manipulate characteristics of that data file, wherein the characteristics that are being manipulated are relevant to a streaming media assets. The manipulation of this data will be described in greater detail below. Additionally, to make the delivery of the streaming media assets more efficient, the system 26 copies, or replicates, the streaming media asset and distributes the replicated streaming media assets across a support system capable of providing multiple hosts for delivering the streaming media asset to a requesting user. In the embodiment depicted in FIG. 1, the support systems for the distribution of replicated data files can include a set of geographically distributed servers, depicted by element 19 of FIG. 1, or from partner networks, such as the Akamai network depicted by element 21 of FIG. 1.

Accordingly, FIG. 1 illustrates that a webhosting service provider that hosts a set of websites, such as the depicted websites 17, can employ the distributed file system 26 described herein for allowing users to employ the client devices 12 to access the services provided by the distributed file system 26 through the webserver 13. By accessing the distributed file system 26 through the webserver 13, the users can remotely control the content stored on their respective websites 17. For example, the distributed file system 26 will allow a user to remotely upload a data file, check it in to the system, edit it if necessary, and allow it to be staged and deployed over a third party network such as the third party content delivery network 21 or directly over the servers 19 provided by that hosting service.

FIG. 2 depicts in more detail the elements of the system 10 that includes customer content 12, a media upload and staging section 14, a distribution section 16, a load balancing and proximity section 18, and a plurality of client devices 20.

For the depicted system, the customer content 12 is streamed content that is derived from a media source 22 and that is encoded by encoder 24 into a format, such as, for example, the Windows Media format or the Apple Quick Time format. The encoded data files are stored as the media-on-demand files 28 depicted in FIG. 2.

The media-on-demand files 28 may be audio files, video files, or any other type of data file that may be streamed over a computer network. These files 28 are delivered into the distributed file system 26 that distributes the files across a plurality of geographically distributed servers 30. The servers 30 of FIG. 2 correspond to the servers depicted by functional blocks 19 and 21 of FIG. 1.

FIG. 2 depicts the distributed file system 26 as a plurality of separate elements, the staging system 14, the distribution section 16, and the load balancing and proximity section 18. The dotted line around functional block elements 14, 16 and 18 are meant to represent an expanded view of the file system 26 as well as the web sites 17 and distribution networks 19 and 21 depicted in FIG. 1. As it will be described in greater detail below the staging platform 14 implements the upload, storage, editing and checking processes depicted in FIG. 1, thereby allowing a file 28 to be replicated as files 31, distributed and checked into the distributed file system 26. As further shown by FIG. 2 the replicated files 31 are transmitted from the staging platform 14 to the distribution platform 16 that comprises the depicted servers 30. The plurality of servers 30 distribute the replicated files 31.

Across the data network, to locate replicated data files 31 at geographic or network locations convenient for serving areas that commonly or heavily request access to the content of media data files 28. The servers 30 control the distribution of replicated files 31 across the staging system 14 and control the distribution of the files 31. The distributed file system 26 maintains information about each of the files. The maintained information may include meta data associated with each of the files. As further shown by FIG. 2 the servers 30 of the distribution platform 16 deliver streaming content to the load balancing proximity section 18. The load balancing and proximity section 18 takes into consideration network resources and other factors including the level of service subscribed to by a client 12 for the streaming of their contents across the data network to the load balancing and proximity section 18 may determine the appropriate quality of service to provide for streaming content of a client 12.

Optionally, the staging platform 14 may comprise two or more nodes where each node is identical and each node is capable of providing a client 12 with access to the services of a distributed file system 26. The two nodes are provided to handle load balancing and provide sufficient computing power to allow for a plurality of customers 12 to use the distributed file system 26 to manage their respective web sites. It will be apparent to those with ordinary skill in the art that the number of DFS nodes, and the architecture employed for providing the distributed file system 26 to customers 12 can vary according to the application, user demand, and other conditions and such modifications and varied architectures do not depart from the scope of the invention.

In operation, the distributed file system 26 allows a user to select a content file 28 to upload to the staging area 14 that will be provided by the distributed file system 26. Typically the client 12 does an FTP upload to the distributed file system 26. Upon detecting the request to FTP a file 28, the web server 13 servicing the customer 12 determines the location of the customer 12 and finds the DFS node 14A or 14B that is closest to, has sufficient capacity, or otherwise is best suited or adequately suited to serve the needs of the customer 12. Upon determining the proper DFS node, the web interface creates an account on the node. The account acts as a staging area 14 from which the file 25 may be replicated, distributed, and checked into the distributed file system 26. For example, once the web interface has identified the proper node 14A or 14B and created an account for the customer 12, a window is presented to the customer 12, through which the customer 12 can select the file 28 to be uploaded. Once the file 28 is uploaded to the staging area 14, meta data is identified from processing the file. The meta data can include the name of the file, its length, its file type, the bandwidth for which it was created, start and stop points, and any other suitable meta data that may be selected from the file. The file 28 and its meta data is then replicated and for each replicated file a unique signature id is created and associated with that physical file. In one embodiment, the unique id is a 128-bit number that is created using a hashing technique that, in one practice hashes the user identification, file name and other information. However, those of ordinary skill in the art will understand that any suitable technique may be employed for creating a unique id for a physical file, and any suitable technique may be employed.

This operation for allowing the user to employ the distributed file system 26 to upload and stage streaming media files is depicted by the flow chart presented by FIG. 3. Specifically FIG. 3 depicts a flow chart of a process 40 that represents a computer process that can execute on a server such as the depicted server 15 and that can provide the distributed file system services described above. In particular, FIG. 3 depicts a process 40 that begins with a step 42. In step 42 the process 40 detects that a user requests to deliver a file up to their web site. The process 40 in step 42 determines a DFS node for servicing the customer. Upon determining the proper DFS node, the process 40 proceeds to step 44 wherein an account on the node is created. The creations of accounts on a node may be achieved any conventional means, including by the having the operating system, such as the UNIX operating system create an account for the user on that node. In optional practices, certain embodiments of the distributed files system 26 can allow for sub accounts to be created for each user wherein different privileges are associate with different accounts and each account is associated with one or more respective web sites 17. The development of software that allows the construction of such accounts and sub accounts follows from principles well known in the art and will be obvious to those of ordinary skill.

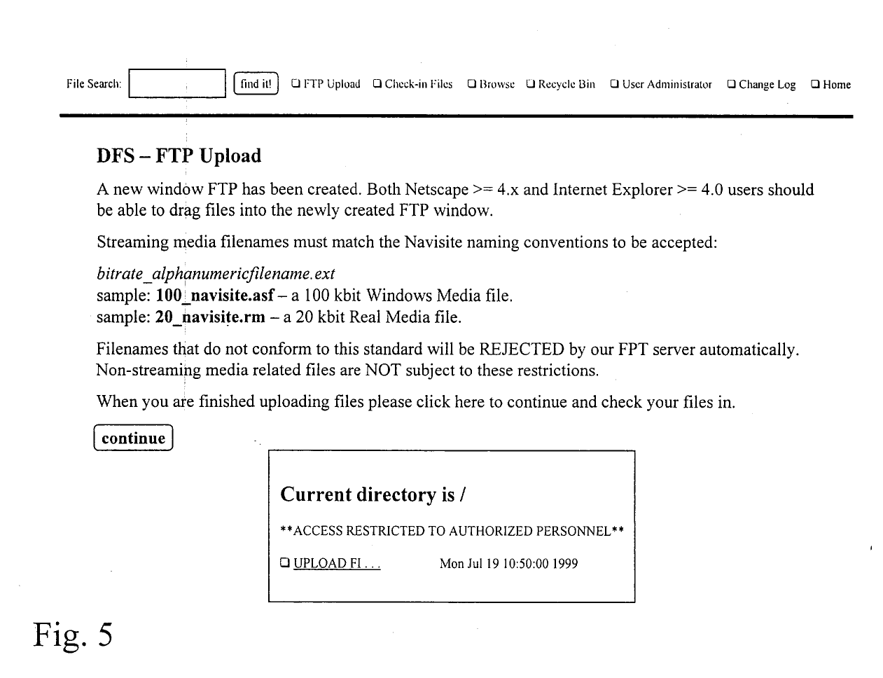

Once the accounts are created the process 40 proceeds to step 48 wherein the user is allowed to select a file to be uploaded. In one practice, the process 40 allows the user to access the distributed files system 26 through a web interface. In this practice, the process 40 can employ the web connection between the customer and the web server of the host to provide graphical user interfaces to the customer. For example, the process 40 may employ the web connection to create user interfaces that allow the user to upload files to the staging area 14, check the files in, and browse the files that are currently stored in the web site. Such user interfaces are depicted in FIGS. 4 and 5. For example, FIG. 4 depicts a user interface that presents the customer with a number of optional services such FTP upload to staging area, check in files, browse files, file search, file recovery, and user account administration features. Each depicted user interface may be a standard HTML page that employs HTML forms and controls to collect input from the customer. FIG. 5 depicts a graphical user interface, also an HTML page, that facilitates file transfer between the client system and the host. To this end the HTML page allows the user to drag a file icon onto the screen of the graphical user interface. The graphical user interface collects the file and automatically begins to upload the file from the client to the host system. After step 48, the process 40 proceeds to step 50 wherein the data file uploaded to the host system is processed to determine, or identify meta data associated with that file. In this step, the process 40 can execute a computer process that is capable of analyzing the contents of the uploaded data file. For example, the file structure of the uploaded data file may be known to the process and may be identified to that process by the file extension associate with the uploaded file. For example, a *.rm file indicates a file format compatible with the Real Media file structure. The process 40 can include logic that understands the file structure of the *.rm format. The file structure typically includes information regarding the title of the file, the size of the file, an associated codec, bit rate and other characteristics of that file.

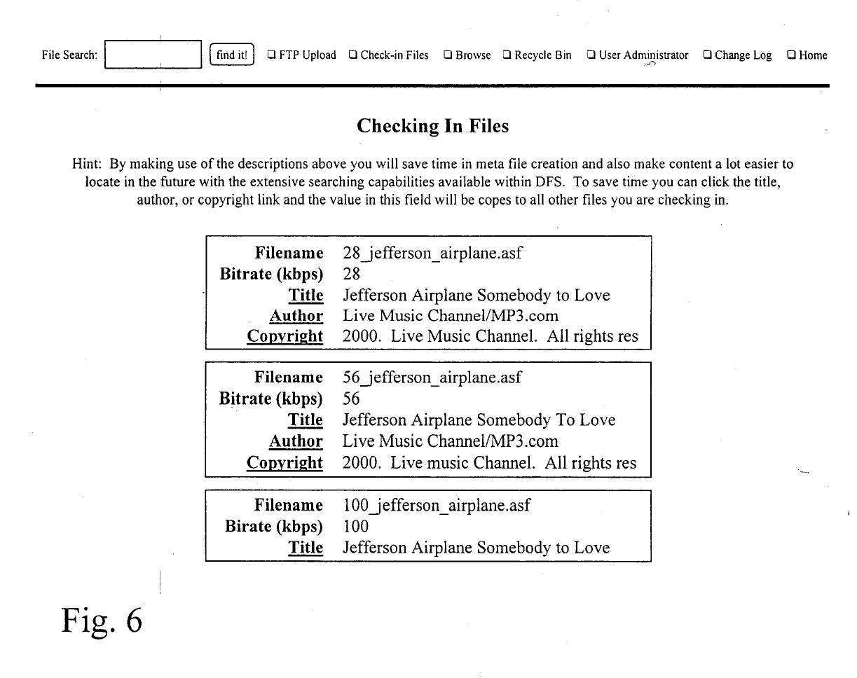

Once the meta data has been identified the process 40 proceeds to step 52 wherein the data file and the meta file are replicated. Optionally for each replicated file a unique signature id may be created and associated with the that physical file. Thus by step 52, the process 40 has uploaded the data file, identified the meta data associated with that file and replicated the data file and the meta data for distribution across the host network, or across a third party content network or networks. To proceed with distribution, the process 40, in step 58 activates the check-in process. The check-in process provides a web interface, depicted in FIG. 6 that presents to the customer the meta data associated with the files that are to be checked into the system. During check-in, the web interface can select a directory structure for entering the created files, the file 28, is replicated, and the replicated meta data are positioned in the staging area 14.

During the check-in phase, the web interface selects a directory structure for entering the created file. In one practice, there is one directory entry per file, where the plural replicated files are associated with that one directory entry. To this end, each directory entry may include pointers to the physical location of a replicated file. Typically, but optionally, the replication process employs a master/slave relationship wherein there is a single master copy of the replicated file and a plurality of replicated slave files. In step 60 each of the replicated files, both masters and slaves, may be located at different nodes across the data network. The meta data associated with each of the files may also be replicated and provided with each file on each node. Techniques for determining which nodes are to be selected for storing a master or slave file are known in the art and any such techniques may be employed. For example, the distribution techniques described by Fast Forward Networks, a subsidiary of Inktomi, may be employed to sufficiently distribute data files across the Internet. However, other techniques may be employed without departing from the scope of the invention.

When determining the number of replicated files to make, as well as where these replicated files are to be located, the systems described herein may employ a profile that is set up for each file uploaded by the customer. The profile may have predetermined characteristics wherein the selected predetermined characteristics for each file turns on the price, or selected quality of service the customer has chosen for that file, or for their service in general. Thus a customer wanting maximum service from the systems described herein may have a profile that indicates a high number of replicated files is to be created and these files are to be distributed across the network including onto servers that are part of third-party customer distribution networks (CDN), such as the Akamai network.

Once the file has been staged, and checked-in, the file may be requested by clients. In this practice, a server may receive a request from an end user such as the depicted computers 20. Based on the profile, user information, and perhaps historical data of earlier similar requests and achieved performance, the server may select the best node to serve the client from, and will generate a redirection link directing the client to make a request to the location best suited to serve that customer. Thus the client should receive service according to the profile selected by the customer website.

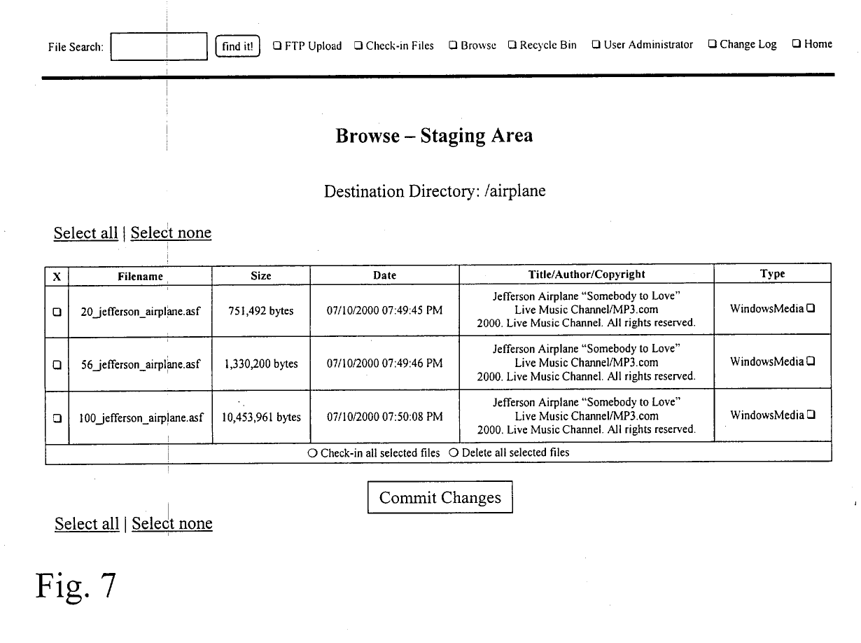

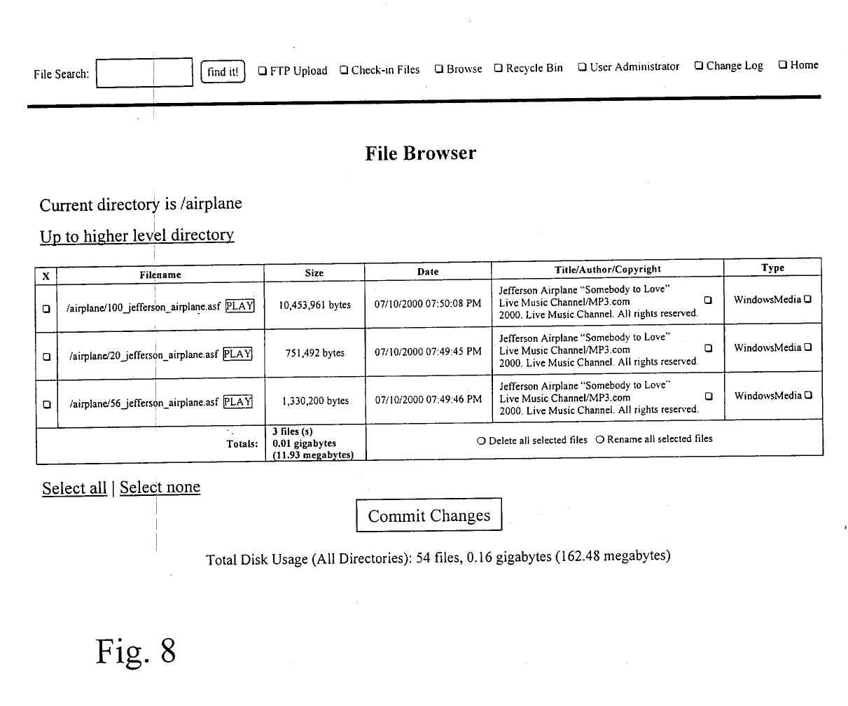

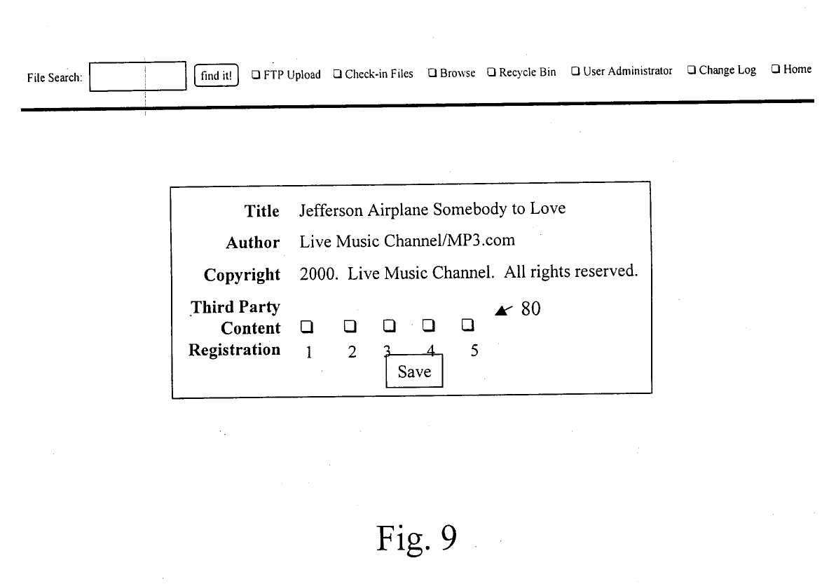

Turning to FIGS. 7-9, it can be seen that the above described distributed file system also provides additional functionality to a user for helping the user manage their web site. For example, FIG. 7 depicts a user interface presented by the system 26 to the client 12 through the browser, that allows the user to browse the different files, and the meta-data associated with those files, that are stored on the user's web site 17. Once the user is satisfied that the meta-data and other characteristics of the stored files are correct, the user can initiate the check-in operation described above with reference to FIG. 3. A similar interface is presented in FIG. 8, however in this interface the user is provided with a play control 70 that allows the user to play the streaming media file through the appropriate player. This allows the user to verify that the file is correct and operating properly, without requiring the user to log into the web site separately or download the file to the client 12 for examination. FIG. 9 depicts a further interface that allows the user to identify which of the content distribution networks the user would like to select for deploying and distributing the streaming media asset. As can be seen in this embodiment, the user can select through the checkbox controls 80, one or more of a plurality of available content distribution networks, similar to how meta-data characteristics are selected. The process 40 of FIG. 3 can process the user selections and register the user's content with the selected content networks for the delivery thereby.

Turning to FIG. 10, it may be understood that a quality of service application may also be provided. Thus the file system 26 described herein can provide tools for monitoring the “Quality of Service” (QOS) for streamed content. Streamed content is more sensitive to quality of service issues than static content. Accordingly, customers will be far more interested in the quality of service provided across the Internet, or other network, when streamed content is being delivered.

To address this issue, the file system 26 may optionally include a quality of service (“QOS”) tool or process that provides bi-directional access to mission critical data related to the intelligent management of streaming media content. In particular, a customer may employ the QOS process to access mission critical data, such as the quality of service being provided to the customer's clientele, when the clientele are located at different locations on the network. To this end, the QOS process communicates with a plurality of monitors across the network. A typical monitor may comprise a Linux Workstation running an agent that simulates the actions of several common media players, such as the Windows Media player and QuickTime Player. The monitor will gather stream-specific data from many different locations throughout the network and transfer the information back to a central depository where it is parsed, processed, and made available for client access and review. The client employing a web interface may access an account provided by the QOS process where the client can view and understand the quality of service that is being achieved for their streams traveling across different paths over the network. Additionally, the distributed file system can use the quality of service information to determine what content will be or has been provided over what paths on the Internet, as well as for selecting paths, networks, or characteristics of paths, for the delivery of content. In this way, the host can offer clients the right to purchase hosting services that have different prices for different subscribed or delivered quality of service.

For example, FIG. 10 depicts that a plurality of agents may be distributed across the data network at certain locations. These agents may imitate the operation of a Windows Media Player, a Real Media Player, or some other type of player. The agents can determine the type of response that they are receiving at that location of the network, and may return a collected information to a central repository that may optionally be maintained at the servers 30. Additionally, and optionally, the quality of service application may also collect the logs from the servers that have been streaming data to the clients. These logs contain information about the success that was achieved when delivering data to an end user station such as the depicted end user stations 40. Accordingly, the QOS application creates a data base of information about the quality of service that has been provided to a customer. In one optional practice, the billing process for a customer turns, in part, on the quality of service that has been provided to that customer during the delivery of streamed content. In this way, the platform described herein may deliver content to a user at a selected cost to that user.

Although FIGS. 1 and 2 graphically depict the distributed file system 26 as an arrangement of functional block elements, it will be apparent to one of ordinary skill in the art that these elements can be realized as computer programs or portions of computer programs that are capable of running on the data processor platform 15 to configure the data processor 15 as a system according to the invention. Moreover, although FIG. 1 depicts the distributed file system 26 as a collection of processes running on a single server platform, it will be apparent to those of ordinary skill in the art that this is only one embodiment, and that the invention can be embodied as a computer program that is distributed across multiple platforms. Additionally, although FIG. 1 depicts the distributed file system as having four processes, it will be understood that this division is merely representational and for the purpose of illustrating the subject matter of the invention. Accordingly, it will be understood that the division of the processes may be achieved or described differently, and for example, the check-in process may be combined with the staging process, and alternatively all four processes may be combined into a single process. Thus, it will be understood that the division of processes illustrated in FIG. 1 is merely exemplary and not to be understood as limiting in any way.

As discussed above, the distributed file system 26 can be realized as a software process operating on a conventional data processing system such as a Unix workstation. In this embodiment, the distributed file system 26 can be implemented as a C language computer program, or a computer program written in any high level language including C++, Fortran, Java or Basic. The design and development of such systems follows from the principles well known in the art including those set forth in the literature including, for example, Stephen G. Kochan, Programming in C, Hayden Publishing (1983).

From the above, it can be seen that the distributed file systems and methods described herein provide a platform that may be employed to create application programs that will employ the distributed file system so that files will be replicated and distributed across a data network. One particular example of such an application program has been described above and provides a customer with a suite of utilities that may be employed for more easily delivering content for streamed applications. However, those skilled in the art will know or be able to ascertain using no more than routine experimentation, many equivalents to the programs, embodiments and practices described herein.

Accordingly, it will be understood that the invention is not to be limited to the embodiments disclosed herein, but is to be understood to be interpreted as broadly as allowed under the law.

We claim:

1. A computer network system for supporting a user in managing streaming media assets, comprising
a server having
an upload process for receiving a media asset having content for being streamed across a data network,
a check-in process for allowing a user to assign meta-data to the media asset,
a storage process for replicating and for storing the media asset across storage devices distributed across the computer network system, and
an editing process for allowing a user to modify the meta-data and for propagating modifications to the meta-data to the replicated and stored media assets.

2. A system according to claim 1, wherein the check-in process allows a user to assign meta-data representative of data selected from the group consisting of file title, file author, run start point, run stop point, and bit rate.

3. A system according to claim 1, wherein the server includes a web server for exchanging data with a web client and for allowing a web client to access services provided thereby.

4. A system according to claim 3, wherein the web client comprises a browser.

5. A system according to claim 1 further including a link generator process for generating an embeddable link for accessing a media asset.

6. A system according to claim 5, wherein the link generator process comprises a process for generating an embeddable link for accessing a media asset stored by the server.

7. A system according to claim 1, wherein the storage process includes an overlay process for storing media assets across a content delivery network.

8. A system according to claim 1, further including a monitoring system having a plurality of agents located on the computer network and capable of monitoring characteristics of a delivery process for transmitting a media asset from the server.

9. A system according to claim 8, wherein the plurality of agents include agents capable of monitoring characteristics representative of the quality of service of the delivery process.

10. A system according to claim 9, wherein the characteristics representative of the quality of service include characteristics selected from the group consisting of average bit-rate, packet loss, and latency.

11. A system according to claim 8, wherein the server further comprises a process for receiving information from at least one of the plurality of agents for generating a report representative of quality of service provided during delivery of a media asset.

12. A system according to claim 11, further comprising
a load balancing system responsive to the information received from the plurality of agents for locating the media asset as a function of network resources.

13. A system according to claim 8, further comprising a distribution system for determining a storage location on the network for the media asset as a function of the network proximity to one or more nodes likely to request access to the respective media asset.

14. A system according to claim 1, further comprising a control system for controlling access of a user to a media asset.

15. A system according to claim 14, wherein said controller includes means for controlling the number of times a user accesses a media asset.

16. A system according to claim 1, further comprising a monitoring system for monitoring use of a media asset and characteristics of the use.

17. A system according to claim 16, further comprising a billing system for determining a billing cost as a function of use of a media asset.

18. A method for supporting a user in delivering a streaming media asset over a data network, comprising
providing a web server for allowing a client to access services for managing the streaming media asset, the web server having access to
an upload process for receiving a media asset having content for being streamed across a data network,
a check-in process for allowing a user to assign meta-data to the media asset,
a storage process for replicating and for storing the media asset across storage devices distributed across the computer network system, and
an editing process for allowing a user to modify the meta-data and for propagating modifications to the meta-data to the replicated and stored media assets, and
allowing a client to access said web server and for employing managing the streaming media asset.

19. A method according to claim 18, further including
providing a service profile representative of a level of service subscribed to by an associated user.

20. A method according to claim 19, further including
determining a cost for delivering a streaming media asset as a function of the subscribed level of service.
